(19) United States
(12) Patent Application Publication
(10) Pub. No.: US 2026/0085781 A1
(43) Pub. Date: Mar. 26, 2026

(54) VELOCITY CONTROL TOW PIG

(71) Applicant: SPARTAN TECHNOLOGY DEVELOPMENT CORP., HOUSTON, TX (US)

(72) Inventors: JUSTIN SCRUGGS, HOUSTON, TX (US); JEFFREY JOHNSTON, HOUSTON, TX (US)

(73) Assignee: SPARTAN TECHNOLOGY DEVELOPMENT CORP, HOUSTON, TX (US)

(21) Appl. No.: 18/896,025

(22) Filed: Sep. 25, 2024

(51) Int. Cl. F16L 55/38; B08B 9/055; F16L 55/40; F16L 101/12; F16L 101/30

(52) U.S. Cl. CPC F16L 55/38; B08B 9/0551; F16L 55/40; B08B 2209/0553; F16L 2101/12; F16L 2101/30

(57) ABSTRACT

A pipeline pig includes a plurality of internal ported windows in a connected valve channel body and an annular bypass space extending around the connected valve channel body between a leading end and a trailing end. The annular bypass space is maximized around an autonomously operated bypass valve in the valve channel body instead of through the valve such that the flow area through the pig valve channel body is approximately equal to the flow area surrounding the pig valve channel body. The sum of the areas of the internal ported windows in the pig have a flow area equal to or greater than the annular area of a pipeline ID minus the area of external diameter of the valve channel body of the pig. The autonomously operated valve is configured to index fore and aft to restrict or open up access to the ported windows.

### CROSS-REFERENCE

This application claims the benefit of U.S. Provisional Application No. 63/590,145, filed Oct. 13, 2023, which application is incorporated herein by reference.

### BACKGROUND OF THE INVENTION

Embodiments of the present invention relate generally to a pipeline pig that is propelled by the pressure of a pipeline fluid flowing through a pipeline. In particular, embodiments of the invention relate to a pipeline pig with a plurality of distinct flow channels extending around the exterior of a valve channel body and an annular bypass space extending around the connected valve channel body and a pipeline ID between a leading end and a trailing end that selectively permit and prohibit flow of the pipeline fluid through the pipeline pig.

### SUMMARY OF THE INVENTION

It is known in the oilfield industry to use a pipeline inspection gauge (commonly referred to as a “pig”) to inspect or clean a pipeline, or to tow a tool through the pipeline. For example, the pig may be used to clean contaminants from an interior wall of the pipeline. The pig also may be used to detect defects, such as pitting, corrosion, a crack, or a weld abnormality, in a wall of the pipeline. These defects may be detected in a variety of ways, including through detection of magnetic flux leakage after developing and while maintaining a magnetic field in the wall of the pipeline. Alternatively, defects may be detected ultrasonically. The pig may also be used to inspect a geometry of the pipeline or determine a location within the pipeline.

Specifically, a pressure differential between upstream and downstream sides of the pig moves the pig from a launching portion, through the pipeline, and ultimately into a receiving portion. The vast majority of traditional pipeline pigs may include an interior channel, and a portion of the fluid (e.g., oil or gas) flowing through the pipeline also flows through the channel. The interior channel allows the fluid to flow through the pig while allowing a pressure on the upstream side of the pig to be greater than a pressure on the downstream side of the pig. Thus, the pig moves downstream as a result of the pressure differential.

There are disadvantages associated with traditional pigs. For example, as the pig moves from the launching portion, through the pipeline, and into the receiving portion, the pressure differentials on the upstream and downstream sides of the pig change. This is because, for example, in a pipe bend, a valve, a section of reduced diameter pipe or some other restriction, the pig may experience a greater resistance to motion than it would in a straight pipe. As the pressure differential between the upstream and downstream sides of the pig changes, the speed of the pig changes.

It is desirable to design the pig so that it moves through the whole pipeline at a speed suitable for cleaning or inspecting the wall of the pipeline, or towing a tool through the pipeline, without going too fast and compromising the quality of the inspection or damaging the pig or the pipeline, or without going too slow and becoming trapped in a restricted bore or radiused section of the pipeline. Further, when the pig is used to inspect the wall of the pipeline by detecting magnetic flux leakage or ultrasonically, the pig needs to move at a speed slow enough to effectively inspect the pipeline but fast enough to avoid becoming trapped in the pipeline. Further still, it is desirable to design the pig so that it can be stopped completely at any specific safe and non-restrictive location. Thus, once the pig is in the pipeline, if the pig is moving too fast to perform the inspection, the pig can be slowed by decreasing the flow rate of the fluid flowing through the pipeline. After moving through the pipeline, the pig needs to also move with sufficient speed to be fully received in the receiving portion.

Alternatively, it is known that traditional pigs may include an interior channel with an outlet through which fluid flows at variable flow rates. As the flow rate of fluid flowing through the outlet varies, the pressure differential between the upstream and downstream sides of the pig, and thus the speed of the pig, changes. The pig suffers from disadvantages, however, including the need for complex arrangements of components to vary the flow rate of the fluid flowing through the outlet, and reduced reliability resulting from complex control equipment. Further still, there is a known theoretical maximum of less than 50% bypass in traditional pig designs.

The disclosure herein overcomes one or more of the above-discussed disadvantages, or other disadvantages, of the known systems or methods.

The disclosure further provides a valve-controlled apparatus configured for traveling inside a pipeline. The apparatus includes a valve body with a channel configured to fit inside the pipeline; a flow channel including an inlet, an outlet comprising a plurality of porting windows dispersed within the valve channel body at or about both the leading (front/inlet) end and the trailing (outlet) end of the valve channel body and an annular bypass space connecting the inlet and the outlet porting windows, the inlet porting windows being configured to receive a substantial portion of a fluid flowing through the pipeline, and the outlet being configured such that the fluid flowing through the annular bypass channel flows out of the annular bypass channel through the outlet windows; a bypass valve within the valve channel body operable to index fore and aft along the leading end of the valve channel to close off or open up access to the leading (front/inlet) porting windows near the leading end of the valve channel body to vary a flow rate of the fluid flowing out of the outlet windows.

The disclosure also discloses a plurality of methods for controlling the speed of an apparatus that travels through a pipeline.

Provided here is a pipeline pig comprising a housing defining a leading end, a trailing end, and longitudinal axis extending therebetween; a connected valve channel body extending longitudinally through the housing between the leading end and the trailing end thereof; a plurality of porting windows dispersed within the valve channel body at or about both the leading end and the trailing end of the valve channel body, opening into an annular bypass space created between the outside diameter of the valve channel body, a rear portion of the leading end and a front portion of the trailing end; and a bypass valve disposed within the valve channel; wherein the bypass valve is operable to index fore and aft along the leading end of the valve channel to close off or open up access to the porting windows near the leading end of the valve channel body.

In some embodiments of the pipeline pig, an annular area (A_{A}), defined by an inside diameter (Pipeline ID) of a pipeline (øD) minus an outside diameter of the valve channel body (ød) of the pig housing, is approximately equal to an inside diameter area (A_{ID}) of the of the valve channel body of the pig housing, wherein the flow area through the leading end and the trailing end of the valve channel body (A_{ID}) is equal to the annular area (A_{A}).

In some embodiments of the pipeline pig, the bypass valve disposed within the valve channel body is autonomously operated.

In some embodiments of the pipeline pig, the bypass valve disposed within the valve channel body comprises pre-programmed modes whereby it can run specific velocity profiles based on distance.

In some embodiments of the pipeline pig, each plurality of porting windows dispersed at both the leading end and the trailing end of the valve channel body have an approximate combined flow area at each end of the valve channel body approximately equal to or greater than the flow area through the leading end and the trailing end of the valve channel body (A_{ID}) and the annular area (A_{A}).

In some embodiments, the pipeline pig further comprises at least a disc seal, or a cup seal, or both on the leading end; and a centralizer on the trailing end.

In some embodiments the pipeline pig further comprises an odometer.

In some embodiments the pipeline pig, further comprises a motor, a portable power source; a Poppet valve; and a power screw.

In some embodiments the pipeline pig further comprises a towing hitch.

In some embodiments of the pipeline pig, the towing hitch is configured for towing other pigs or tools.

In some embodiments of the pipeline pig, the pig is configured for towing other tools such as 3^{rd} party cleaning and logging tools.

In some embodiments of the pipeline pig, the pig is configured for towing any variety of existing tubular tool technologies; or comparable tool technologies to be invented.

In some embodiments of the pipeline pig, the annular area (A_{A})=π/4 ((øD)²−(ød)²).

In some embodiments of the pipeline pig, the annular area of the valve channel body internal diameter (A_{ID}) of the pipeline pig=π/4 (ød)².

In some embodiments of the pipeline pig, the valve channel body external diameter (ød) of the pipeline pig is determined by setting the annular area (A_{A}) equal to the annular area of the valve channel body internal diameter (A_{ID}) and solving for ød.

In some embodiments of the pipeline pig, the bypass valve disposed within the valve channel body creates a restrictive flow condition for liquid/gas when indexed toward the leading end of the bypass channel and covering or closing off all or part of the porting windows.

In some embodiments of the pipeline pig, the autonomous bypass valve disposed within the valve channel body is configured to create a restrictive configuration in the pig in which a pipeline fluid is restricted or prohibited from flowing through from the front/leading end porting windows and through the annular bypass space based on the measured velocity of the tool as measured by the Odometer wheels.

In some embodiments of the pipeline pig, the autonomous bypass valve is indexed to move to a bypass configuration thereby opening the leading end porting windows in which the pipeline fluid is permitted to flow through the leading end porting windows into the annular bypass space and out of the trailing end porting windows in response to the velocity of the pig caused by the differential pressure reaching a pre-selected minimum bypass pressure.

In some embodiments, the pipeline pig further comprises a closed loop feedback system, monitored and controlled by a logic device.

In some embodiments of the pipeline pig, said closed loop feedback system is configured to: measure the pipeline pig velocity; adjust the poppet valve position via the power screw to control the bypass valve and open or close the leading porting window openings in order to control velocity; to alter or change velocity profiles or select different preset velocity profiles; and to monitor power source conditions.

In some embodiments, the pipeline pig further comprises a transmitter to provide an end-user with tracking capability and to receive data on the condition of the pipeline pig components and velocity.

In some embodiments of the pipeline pig, a logic board comprises user-selectable software to provide various modes of operation of the tool including constant velocity control; pre-programmed velocity profiles based on distance; and velocity based on the tension of towing loads.

In some embodiments of the pipeline pig, the disc seal is provided as a guide to keep the pig centralized in a pipeline when the pig is navigating turns or bends in the pipeline, and to act as a redundancy for the cup seal to ensure that fluid flow passes through the pig instead of around it.

In some embodiments of the pipeline pig, the centralizer is configured as a segmented cup seal and further comprises flexible segments; and odometer wheels mounted thereon.

In some embodiments of the pipeline pig, the flexible segments comprise spring-like properties to ensure and maintain positive contact pressure between the odometer wheels and an inner diameter of a pipeline.

In some embodiments of the pipeline pig, the tool can be fabricated from a pipe or tubing with no welding required; wherein the disc seal, the cup seal and centralizer mount to the tool with removeable fasteners through the sidewall of the pipe or tubing, and wherein the odometer wheels are mounted directly to the segmented centralizer having flexural properties.

Provided herein is a simplified pipeline pig comprising: a housing defining a leading end, a trailing end, and longitudinal axis extending therebetween; a singular connected valve channel body extending longitudinally through the housing between the leading end and the trailing end thereof; said valve channel body comprising a plurality of porting windows dispersed at or about both the leading end and the trailing end of the valve channel body, opening into an annular bypass space created between the outside diameter of the valve channel body, a rear portion of the leading end and a front portion of the trailing end; at least one seal-like component at or about each of the leading end and the trailing end; an autonomously operated bypass valve disposed within the valve channel body; wherein the simplified pig is constructed using removeable components that are attached using removeable fasteners through a sidewall of the valve channel body.

In some embodiments of the simplified pipeline pig, the autonomously operated bypass valve is operable to index fore and aft along the plurality of front/leading porting windows of the valve channel body to close off or open up access to the front/leading porting windows in order to restrict or allow fluid flow through the pig and to control the pig velocity.

In some embodiments of the simplified pipeline pig, an annular area, defined by an inside diameter of a pipeline, minus an outside diameter of the valve channel body of the pig housing, is approximately equal to an inside diameter area of the of the valve channel body of the pig housing; wherein the flow area through the leading end and the trailing end of the valve channel body is equal to the annular area; and wherein the flow area through the pig is approximately equal to the flow area surrounding the pig within a pipe ID.

In some embodiments, the simplified pipeline pig further comprises an odometer, a motor, a portable power source; a Poppet valve; and a power screw.

In some embodiments, the simplified pipeline pig further comprises a towing hitch.

In some embodiments, the simplified pipeline pig further comprises a microcontroller; or a personal computer (PC); or a digital signal processor (DSP); or system on a chip; a logic board; user-selectable software to provide various modes of operation of the tool including: a constant velocity control; a plurality of pre-programmed velocity profiles based on distance; and a plurality of pre-programmed velocity profiles based on towing loads; and a transmitter to provide an end-user with tracking capability and to receive data on the condition of the pipeline pig components and velocity.

In some embodiments, the simplified pipeline pig alternately comprises an analog control system comprising: a series of op amps; transistors; and comparators to perform the same control logic as the digital system.

In some embodiments, the simplified pipeline pig has at least three modes of operation comprising: Velocity Control; Tension Control; and Distance-based or Time-based Controlled Stops.

In some embodiments of the simplified pipeline pig, wherein with velocity control, using an odometer, the control system may employ a proportional-integral-derivative controller (PID controller or three-term controller) to continuously monitor the speed of the pig and adjust the bypass valve accordingly, wherein a PID loop would decrease the amount of pipeline fluid, liquid or gas bypassed to increase the speed if the speed is measured as lower than the setpoint; or wherein the PID controller may be used to set a plurality of speed operating points based on distance travelled; or wherein the PID controller may be used to set a plurality of speed operating points based elapsed time.

In some embodiments of the simplified pipeline pig, wherein using tension control the speed of the pig may be controlled using a load cell in the towing hitch of the pig; wherein the controller may be able to measure the tension of the pig being towed by the simplified pig; wherein the control system may be used to increase or decrease the bypass to maintain a constant tension in the towing hitch; or wherein the control system may be used to set several tension operating points-based distance travelled; or wherein the control system may be used to set several tension operating points based on elapsed time.

In some embodiments of the simplified pipeline pig, wherein using Distance-based or Time-based Controlled Stops, based on the increased bypass this mechanical topology will provide, the control system will be able to implement set points for the pig to come to a complete stop in the pipeline, wherein, the system may make ultra-high definition measurements, sample at a specific point for a duration of time and tow tools to perform mechanical maintenance and operations to the pipeline at predetermined locations.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side view of the pipeline pig.

FIG. 2 is a longitudinal cross-section view of the pipeline pig.

FIG. 3 is a front-end view of the pipeline pig.

FIG. 4 is a rear-end view of the pipeline pig.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

The present device will now be described more fully hereinafter with reference to the accompanying drawings which illustrate embodiments of the pipeline pig. This pipeline pig may, however, be embodied in many different forms and should not be construed as limited to the illustrated embodiments set forth herein. Rather, these embodiments are provided so that this disclosure will be thorough and complete, and will fully convey the scope of the device to those skilled in the art.

The following description of the exemplary embodiments refers to the accompanying drawings. The following detailed description does not limit the invention. Instead, the scope of the invention is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

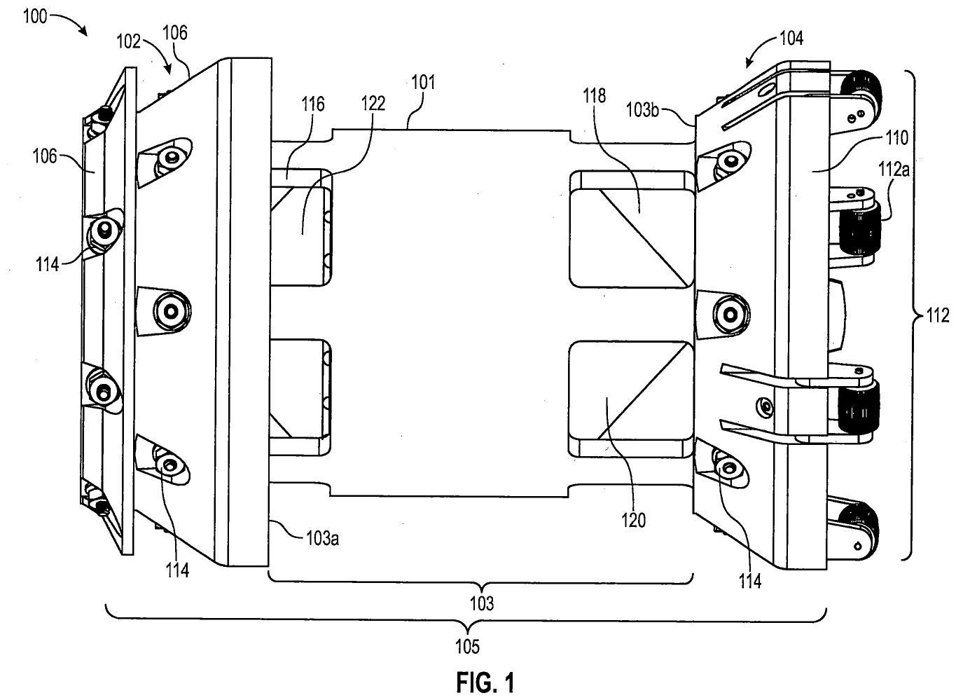

Referring to FIG. 1, a side view of the velocity control pipeline pig 100, is constructed in accordance with an exemplary embodiment of the present invention, and is disposed within an interior of pipeline, not shown. Pipeline pig 100 includes a housing 105 having a leading end 102, a trailing end 104, and longitudinal axis extending therebetween; a connected or valve channel body 101 extending longitudinally through the housing 105 between the leading end and the trailing end thereof; a plurality of porting windows 116, 118 dispersed within the valve channel body at or about both the leading end (116/102) and the trailing end (118/104) of the valve channel body, opening into an annular bypass space 103 created between the outside diameter of the valve channel body 101, a rear portion of the leading end 103a and a front portion of the trailing end 103b; and a bypass valve 120 disposed within the valve channel; wherein the bypass valve is operable to index fore and aft between the leading end 102 and the trailing end 104 of the valve channel to close off or open up access to the porting windows 116 near the leading end of the valve channel body.

In some embodiments of the pipeline pig, an annular area (A_{A}), defined by an inside diameter (Pipeline ID) of a pipeline (øD) (not shown) minus an outside diameter of the valve channel body 101 (ød) of the pig housing 105, is approximately equal to an inside diameter area (A_{ID}) of the of the valve channel body 101 of the pig housing, wherein the flow area through the leading end 102 and the trailing end 104 of the valve channel body 101 (A_{ID}) is equal to the annular area (A_{A}).

In some embodiments of the pipeline pig, the bypass valve 120 disposed within the valve channel body 101 is autonomously operated.

In some embodiments, the pipeline pig further comprises at least a disc seal 106, or a cup seal 108, or both (106, 108) on the leading end 102; and a centralizer 110 on the trailing end 104.

In some embodiments the pipeline pig, further comprises an odometer 112. In the exemplary embodiment shown, the odometer 112 comprises a plurality of odometer wheels 112a, space around the perimeter of the centralizer such that at least one odometer wheel is always in contact with the ID of the pipeline (not shown), including when the pig is travelling around bends in the pipeline.

Still referring to FIG. 1, a portion of a Poppet valve 122 is visible within the leading end of the porting windows 116. It should also be noted that the Disc Seal 106, the Cup Seal 108, and the Centralizer 110 are all removably assembleable with bolts and nuts 114, or comparable fasteners, whereas the industry standard has usually been to weld all of these components together, making the cost of repair or replacement much higher, when needed.

In some embodiments of the pipeline pig 100, the bypass valve 120 disposed within the valve channel body comprises pre-programmed modes whereby it can run specific velocity profiles based on distance. 0065. In some embodiments of the pipeline pig 100, each plurality of porting windows 116, 118 dispersed at both the leading end (102) and the trailing end (104) respectively of the valve channel body have an approximate combined flow area at each end of the valve channel body approximately equal to or greater than the flow area through the leading end and the trailing end of the valve channel body (A_{ID}) and the annular area (A_{A}).

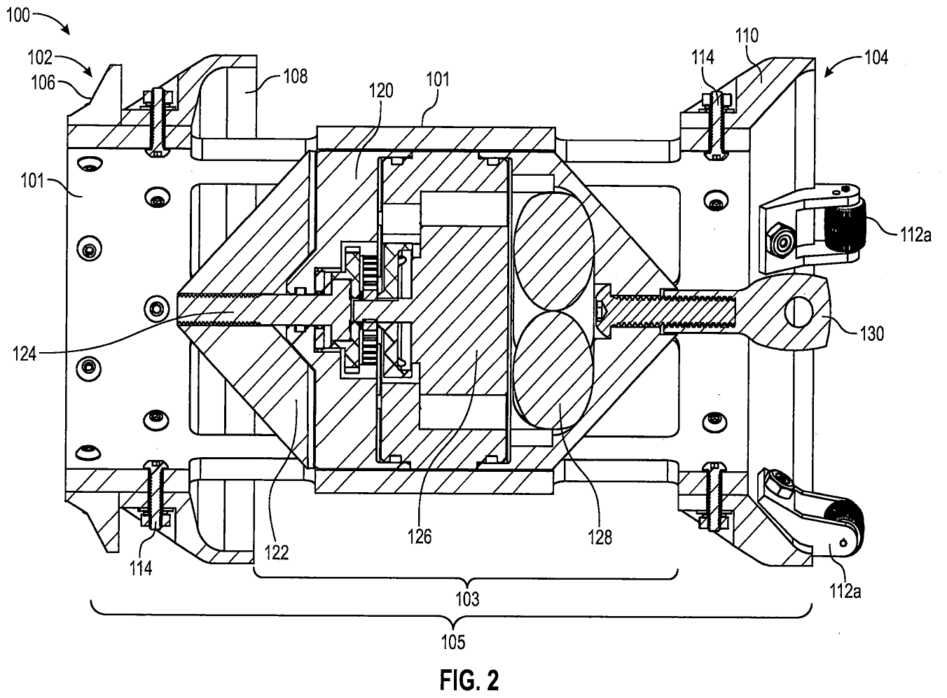

Referring now to FIG. 2, a longitudinal cross-section view of the velocity control pipeline pig 100, is constructed in accordance with an exemplary embodiment of the present invention, and is disposed within an interior of pipeline, (not shown). In some embodiments, the pipeline pig is a Tow Pig and further comprises a motor 126, a portable power source 128 (i.e.: lithium batteries, alkaline batteries, Nickel-Cadmium (Ni—Cd), NiMH batteries, lithium-nickel-cobalt-aluminum (NCA) chemistry batteries, lithium-nickel-manganese-cobalt (NMC) batteries, lithium-iron phosphate (LPF), and batteries with silicon-infused graphite anodes); a Poppet valve 122; and a power screw 124.

In some embodiments the pipeline tow pig 100, further comprises a towing hitch 130.

In some embodiments of the pipeline tow pig, the towing hitch 130 is configured for towing other pigs or tools.

In some embodiments of the pipeline pig, the pig is configured for towing other tools such as 3^{rd} party cleaning and logging tools. These configurations may use an alternate towing hitch device other than the towing hitch 130.

In some embodiments of the pipeline pig, the pig is configured for towing any variety of existing tubular tool technologies; or comparable tool technologies to be invented. These configurations may use an alternate towing hitch device other than the towing hitch 130.

In some embodiments of the pipeline pig, the annular area (A_{A})=π/4 ((øD)²−(ød)²).

In some embodiments of the pipeline pig, the annular area of the valve channel body internal diameter (A_{ID}) of the pipeline pig=π/4 (ød)².

In some embodiments of the pipeline pig, the valve channel body external diameter (ød) of the pipeline pig is determined by setting the annular area (A_{A}) equal to the annular area of the valve channel body internal diameter (A_{ID}) and solving for ød.

In some embodiments of the pipeline pig 100, the bypass valve 120 disposed within the valve channel body 101 creates a restrictive flow condition for fluid, liquid/gas when indexed toward the leading end 102 of the bypass channel and covering or closing off all or part of the porting windows 116.

In some embodiments of the pipeline pig, the autonomous bypass valve disposed within the valve channel body is configured to create a restrictive configuration in the pig in which a pipeline fluid is restricted or prohibited from freely flowing through from the trailing end 104 porting windows 118 and through the annular bypass space 103 based on the measured velocity of the tool as measured by the Odometer wheels 112a, hence providing velocity control.

In some embodiments of the pipeline pig, the autonomous bypass valve 120 is indexed to move to a bypass configuration thereby opening the leading end porting windows 116 in which the pipeline fluid is permitted to flow through the leading end porting windows 116, into the annular bypass space 103 and out of the trailing end porting windows 118 in response to the velocity of the pig caused by the differential pressure reaching a pre-selected minimum bypass pressure.

In some embodiments, the pipeline pig further comprises a closed loop feedback system, monitored and controlled by a logic device. In some embodiments, a PCB with the battery management system (BMS), microcontroller and motor driver would be housed on a PCB within the pressure vessel with the motor.

In some embodiments of the pipeline pig, said closed loop feedback system is configured to: measure the pipeline pig velocity; adjust the poppet valve 122 position via the power screw 124 to control the bypass valve 120 and open or close the porting window openings 116, 118 in order to control velocity; to alter or change velocity profiles or select different preset velocity profiles; and to monitor power source 128 conditions.

In some embodiments, the pipeline pig further comprises a transmitter to provide an end-user with tracking capability and to receive data on the condition of the pipeline pig components and velocity.

In some embodiments, the transmitter would be an inductive coil driven with an H-bridge driver at 15 Hz to 22 Hz which is the industry standard. This would also be housed with the electronics in the pressure vessel.

In some embodiments of the pipeline pig, a logic board comprises user-selectable software to provide various modes of operation of the tool including constant velocity control; pre-programmed velocity profiles based on distance; and velocity based on towing loads. In some embodiments the software would be either phone-based web portals, app-based or PC based. In some embodiments the communication would be wired, wireless or both.

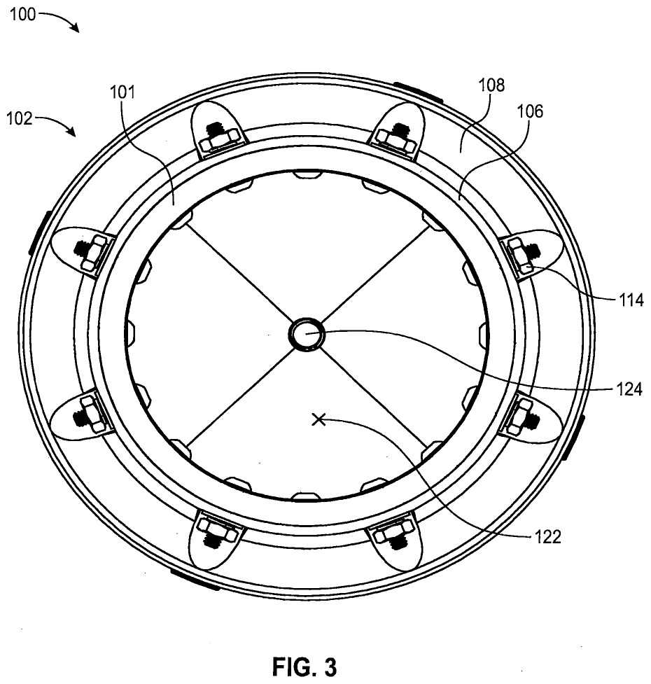

Referring now to FIG. 3, a front or leading end 102 view of the velocity control pipeline pig 100, some embodiments of the pipeline pig comprise the disc seal 106, provided as a guide to keep the pig centralized in a pipeline when the pig is navigating turns or bends in the pipeline, and to act as a redundancy for the cup seal 108 to ensure that fluid flow passes through the pig instead of around it.

Also visible in FIG. 3, one can see the end view of the Poppet Valve 122 described previously, and the Power Screw 124 to open and close the Poppet valve.

As noted previously, both the disc seal 106 and the cup seal 108 are configured to be removably assembleable bolts and nuts 114, or comparable fasteners, whereas the industry standard has usually been to weld all of these components together, making the cost of repair or replacement much higher, when needed.

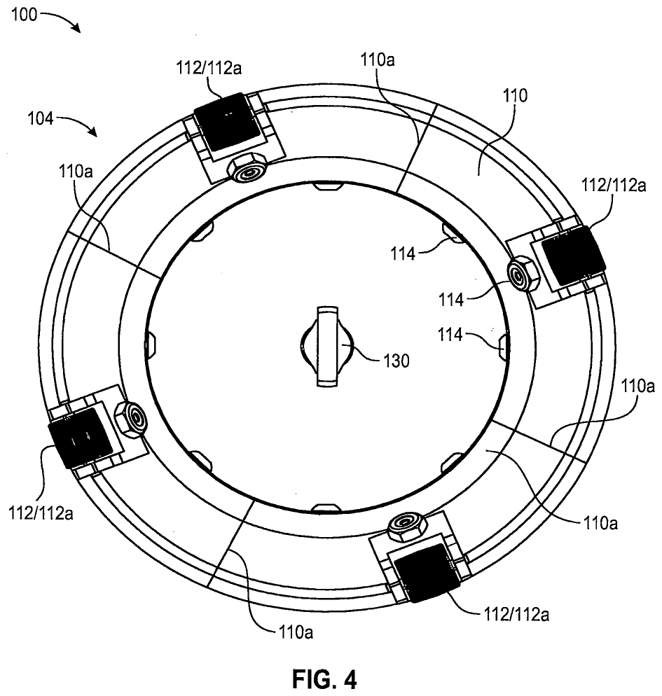

Referring now to FIG. 4, a rear or trailing end 104 view of the velocity control pipeline pig 100, some embodiments of the pipeline pig comprise the centralizer 110, configured as a segmented cup seal and further comprising a plurality of flexible segments 110a and odometer wheels 112a mounted thereon. Alternately, the centralizer could be configured as a non-segmented cup seal, depending on the material selection for the centralizer.

In some embodiments of the pipeline pig, the flexible segments comprise spring-like properties to ensure and maintain positive contact pressure between the odometer wheels and an inner diameter of a pipeline.

In some embodiments, appropriate materials for the centralizer or centralizer segments may comprise polyurethane or urethane.

In some embodiments of the pipeline pig, the tool can be fabricated from a pipe or tubing with no welding required; wherein the disc seal 106, the cup seal 108 and centralizer 110 mount to the tool with removeable fasteners 114 through the sidewall of the pipe or tubing, and wherein the odometer wheels are mounted directly, also with removeable fasteners 114, to the segmented (or non-segmented) centralizer having flexural properties.

Provided herein is a simplified pipeline pig 100 comprising: a housing 105 defining a leading end 102, a trailing end 104, and longitudinal axis extending therebetween; a singular connected valve channel body 101 extending longitudinally through the housing between the leading end and the trailing end thereof; said valve channel body 101 comprising a plurality of porting windows 116/118 dispersed at or about both the leading end 102/116 and the trailing end 104/118 of the valve channel body 101, opening into an annular bypass space 103 created between the outside diameter of the valve channel body 101, a rear portion of the leading end 102, at or about the maximum diameter of the cup seal 108 and a anterior edge portion of the centralizer 110 on the trailing end 104; at least one seal-like component 106/108 at or about the leading end 102 and at least one seal-like (centralizer) component 110 at or about the trailing end 104; an autonomously operated bypass valve 120 disposed within the valve channel body 101; wherein the simplified pig is constructed using removeable components that are attached using removeable fasteners 114 through a sidewall of the valve channel body.

In some embodiments of the simplified pipeline pig, the autonomously operated bypass valve 120 is operable to index fore and aft between the plurality of porting windows 116/118 of the valve channel body 101 to close off or open up access to the leading porting windows in order to control the pig velocity.

In some embodiments of the simplified pipeline pig, an annular area 103, defined by an inside diameter of a pipeline (not shown), minus an outside diameter of the valve channel body 101 of the pig housing 105, is approximately equal to an inside diameter area of the of the valve channel body 101 of the pig housing; wherein the flow area through the leading end 102 and the trailing end 104 of the valve channel body 101 is approximately equal to the annular area 103; wherein the flow area through the pig is approximately equal to the flow area surrounding the pig within a pipe ID.

In some embodiments, the simplified tow pipeline pig further comprises an odometer 112, 112a, a motor 126, a portable power source (batteries) 128; a Poppet valve 122; and a power screw 124.

In some embodiments, the simplified pipeline tow pig further comprises a towing hitch 130.

In some embodiments of the pipeline pig, the pig is configured for towing other tools such as 3^{rd} party cleaning and logging tools. These configurations may use an alternate towing hitch device other than the towing hitch 130.

In some embodiments of the pipeline pig, the pig is configured for towing any variety of existing tubular tool technologies; or comparable tool technologies to be invented. These configurations may use an alternate towing hitch device other than the towing hitch 130.

In some embodiments, the simplified pipeline pig further comprises a digital closed-loop feedback system comprising: a microcontroller; a personal computer (PC); or a digital signal processor (DSP); or system on a chip (SoC); a logic board; user-selectable software to provide various modes of operation of the tool including: a constant velocity control; a plurality of pre-programmed velocity profiles based on distance; and a plurality of pre-programmed velocity profiles based on towing loads; and a transmitter to provide an end-user with tracking capability and to receive data on the condition of the pipeline pig components and velocity.

In some embodiments, the simplified pipeline pig alternately comprises an analog control system comprising: a series of op amps; transistors; and comparators to perform the same control logic as the digital system.

In some embodiments, the simplified pipeline pig has at least three modes of operation comprising: Velocity Control; Tension Control; and Distance-based or Time-based Controlled Stops.

In some embodiments of the simplified pipeline pig, wherein with velocity control, using an odometer, the control system may employ a proportional-integral-derivative controller (PID controller or three-term controller) to continuously monitor the speed of the pig and adjust the bypass valve accordingly, wherein a PID loop would decrease the amount of pipeline fluid, liquid or gas bypassed, or to increase the speed if the speed is measured as lower than the setpoint; or wherein the PID controller may be used to set a plurality of speed operating points based on distance travelled; or wherein the PID controller may be used to set a plurality of speed operating points based elapsed time.

In some embodiments of the simplified pipeline pig, wherein with velocity control, using an odometer, the control system may employ a proportional-integral-derivative controller (PID controller or three-term controller) to continuously monitor the speed of the pig and adjust the bypass valve accordingly, wherein a PID loop would increase the amount of pipeline fluid, liquid or gas bypassed, to slow or to stop the speed if desired. In some embodiments, the PID would be configurable to allow the simplified pipeline pig to stop.

In some embodiments of the simplified pipeline pig, wherein using tension control the speed of the pig may be controlled using a load cell in the towing hitch of the pig; wherein the controller may be able to measure the tension of the pig being towed by the simplified pig; wherein the control system may be used to increase or decrease the bypass to maintain a constant tension in the towing hitch; or wherein the control system may be used to set several tension operating points-based distance travelled; or wherein the control system may be used to set several tension operating points-based elapsed time.

In some embodiments of the simplified pipeline pig, wherein using Distance-based or Time-based Controlled Stops, based on the increased bypass this mechanical topology will provide, the control system will be able to implement set points for the pig to come to a complete stop in the pipeline, wherein, the system may make ultra-high definition measurements, sample at a specific point for a duration of time and tow tools to perform mechanical maintenance and operations to the pipeline at predetermined locations.

While certain embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A pipeline pig comprising:
a housing defining a leading end, a trailing end, and a longitudinal axis extending therebetween;
a connected valve channel body extending longitudinally through the housing between the leading end and the trailing end thereof;
a plurality of porting windows dispersed within the valve channel body at or about both the leading end and the trailing end of the valve channel body, opening into an annular bypass space created between an outside diameter of the valve channel body, a rear portion of the leading end and a front portion of the trailing end; and
a bypass valve disposed within the valve channel body;
wherein the bypass valve is operable to index fore and aft between the leading end and the trailing end of the valve channel body to close off or open up access to the porting windows near the leading end of the valve channel body.

2. The pipeline pig of claim 1, wherein an annular area (A_{A}), defined by an inside diameter (Pipeline ID) of a pipeline (øD) minus an outside diameter of the valve channel body (ød) of the pig housing, is approximately equal to an inside diameter area (A_{ID}) of the of the valve channel body of the pig housing
wherein a flow area through the leading end and the trailing end of the valve channel body (A_{ID}) is equal to the annular area (A_{A}).

3. The pipeline pig of claim 1, wherein the bypass valve disposed within the valve channel body is autonomously operated.

4. The pipeline pig of claim 3, wherein the bypass valve disposed within the valve channel body comprises pre-programmed modes whereby it can run specific velocity profiles based on distance.

5. The pipeline pig of claim 2, wherein each plurality of porting windows dispersed at both the leading end and the trailing end of the valve channel body have an approximate combined flow area at each end of the valve channel body approximately equal to or greater than the flow area through the leading end and the trailing end of the valve channel body (A_{ID}) and the annular area (A_{A}).

6. The pipeline pig of claim 1, further comprising:
at least a disc seal, or a cup seal, or both on the leading end; and
a centralizer on the trailing end.

7. The pipeline pig of claim 6, further comprising an odometer.

8. The bypass valve of claim 6, further comprising:
a motor,
a portable power source;
a Poppet valve; and
a power screw.

9. The pipeline pig of claim 6, further comprising a towing hitch or alternate towing hitch device.

10. The pipeline pig of claim 9, wherein the towing hitch or alternate towing hitch device is configured for towing at least one of;
other pigs;
cleaning tools;
logging tools;
any variety of existing tubular tool technologies; or
comparable tool technologies to be invented.

11. The pipeline pig of claim 2, wherein the annular area (A_{A})=π/4 ((øD)²−(ød)²).

12. The pipeline pig of claim 2, wherein the annular area of the valve channel body internal diameter (A_{ID}) of the pipeline pig=π/4 (ød)².

13. The pipeline pig of claim 2, wherein the valve channel body external diameter (ød) of the pipeline pig is determined by setting the annular area (A_{A}) equal to the annular area of the valve channel body internal diameter (A_{ID}) and solving for ød.

14. The pipeline pig of claim 6, wherein the bypass valve disposed within the valve channel body creates a restrictive flow condition for fluid, liquid/gas when indexed toward the leading end of the bypass channel and covering or closing off all or part of the porting windows.

15. The pipeline pig of claim 3, wherein the autonomous bypass valve disposed within the valve channel body is configured to create a restrictive configuration in the pig in which a pipeline fluid is restricted or prohibited from flowing through from the trailing end porting windows and through the annular bypass space, by covering or closing off all or part of the leading porting windows based on the measured velocity of the tool as measured by the Odometer wheels.

16. The pipeline pig of claim 15, wherein the autonomous bypass valve is indexed to move to a bypass configuration thereby opening the leading end porting windows in which the pipeline fluid is permitted to flow through the leading end porting windows into the annular bypass space and out of the trailing end porting windows in response to the velocity of the pig caused by the differential pressure reaching a pre-selected minimum bypass pressure.

17. The pipeline pig of claim 1, further comprising a closed loop feedback system, monitored and controlled by a logic device.

18. The pipeline pig of claim 17, wherein said closed loop feedback system is configured to:
measure the pipeline pig velocity;
adjust the poppet valve position via the power screw to control the bypass valve to open or close the leading porting window openings in order to control velocity;
to alter or change velocity profiles or select different preset velocity profiles; and
to monitor power source conditions.

19. The pipeline pig of claim 1, further comprising a transmitter to provide an end-user with tracking capability and to receive data on the condition of the pipeline pig components and velocity.

20. The pipeline pig of claim 18, wherein a logic board comprises user-selectable software to provide various modes of operation of the tool including:
constant velocity control;
pre-programmed velocity profiles based on distance; and
velocity based on towing loads.

21. The pipeline pig of claim 6, wherein the disc seal is provided as a guide to keep the pig centralized in a pipeline when the pig is navigating turns or bends in the pipeline, and to act as a redundancy for the cup seal to ensure that fluid flow passes through the pig instead of around it.

22. The pipeline pig of claim 6, wherein the centralizer is configured as a segmented cup seal and further comprises:
flexible segments; and
odometer wheels mounted thereon.

23. The pipeline pig of claim 22, wherein the flexible segments comprise spring-like properties to ensure and maintain positive contact pressure between the odometer wheels and an inner diameter of a pipeline.

24. The pipeline pig of claim 1, wherein the tool can be fabricated:
from a pipe or tubing; and
with no welding required;
wherein the disc seal, the cup seal and centralizer mount to the tool with removeable fasteners through the sidewall of the pipe or tubing, and
wherein the odometer wheels are mounted directly to the segmented centralizer having flexural properties.

25. A simplified pipeline pig comprising:
a housing defining a leading end, a trailing end, and a longitudinal axis extending therebetween;
a singular connected valve channel body extending longitudinally through the housing between the leading end and the trailing end thereof;
said singular connected valve channel body comprising a plurality of porting windows dispersed at or about both the leading end and the trailing end of the valve channel body, opening into an annular bypass space created between an outside diameter of the valve channel body, a rear portion of the leading end and a front portion of the trailing end;
at least one seal-like component at or about the leading end and at least one other seal-like component at or about the trailing end;
an autonomously operated bypass valve disposed within the valve channel body; wherein the simplified pig is constructed using removeable components that are attached using removeable fasteners through a sidewall of the valve channel body.

26. The simplified pipeline pig of claim 25, wherein the autonomously operated bypass valve is operable to index fore and aft between the plurality of porting windows of the valve channel body to close off or open up access to the leading porting windows to control the simplified pipeline pig velocity.

27. The pipeline pig of claim 25, wherein an annular area, defined by an inside diameter of a pipeline, minus an outside diameter of the valve channel body of the pig housing, is approximately equal to an inside diameter area of the of the valve channel body of the pig housing;
wherein the flow area through the leading end and the trailing end of the valve channel body is equal to the annular area; and
wherein the flow area through the pig is approximately equal to the flow area surrounding the pig within a pipe ID.

28. The simplified pipeline pig of claim 25, further comprising:
an odometer;
a motor;
a portable power source;
a Poppet valve; and
a power screw.

29. The pipeline pig of claim 28, further comprising a towing hitch or alternate towing hitch device.

30. The pipeline pig of claim 28, further comprising a closed-loop feedback system comprising:
a microcontroller; or
a personal computer (PC); or
a digital signal processor (DSP); or
a system on a chip;
a logic board;
a user-selectable software to provide various modes of operation of the tool including:
a constant velocity control;
a plurality of pre-programmed velocity profiles based on distance; and
a plurality of pre-programmed velocity profiles based on towing loads; and
a transmitter to provide an end-user with tracking capability and to receive data on the condition of the pipeline pig components and velocity.

31. The simplified pipeline pig of claim 30, alternately comprising an analog control system comprising:
a series of op amps;
transistors; and
comparators;
to perform the same control logic as the digital system.

32. The simplified pipeline pig of claim 25, having at least three modes of operation comprising:
Velocity Control;
Tension Control; and
Distance-based or Time-based Controlled Stops.

33. The simplified pipeline pig of claim 32, wherein with velocity control, using an odometer, the control system may employ a proportional-integral-derivative controller (PID controller or three-term controller) to continuously monitor the speed of the pig and adjust the bypass valve accordingly, wherein a PID loop would decrease the amount of pipeline fluid, liquid or gas bypassed, to increase the speed if the speed is measured as lower than the setpoint; or
wherein the PID controller may be used to set a plurality of speed operating points based on distance travelled; or
wherein the PID controller may be used to set a plurality of speed operating points based elapsed time.

34. The simplified pipeline pig of claim 32, wherein using tension control, the speed of the pig may be controlled using a load cell in the towing hitch or alternate towing hitch device of the pig;
wherein the controller may be able to measure the tension of the pig being towed by the simplified pig;
wherein the control system may be used to increase or decrease the bypass to maintain a constant tension in the towing hitch or alternate towing hitch device; or
wherein the control system may be used to set several tension operating points-based distance travelled; or
wherein the control system may be used to set several tension operating points based elapsed time.

35. The simplified pipeline pig of claim 32, wherein using Distance-based or Time-based Controlled Stops, based on the increased bypass this mechanical topology will provide, the control system will be able to implement set points for the pig to come to a complete stop in the pipeline,
wherein, the system may make ultra-high-definition measurements, sample at a specific point for a duration of time, and tow tools to perform mechanical maintenance and operations to the pipeline at predetermined locations.
